(19) United States
(12) Patent Application Publication
(10) Pub. No.: US 2023/0369657 A1
(43) Pub. Date: Nov. 16, 2023

(54) SECONDARY BATTERY

(71) Applicant: Zhuhai CosMX Battery Co., Ltd., Guangdong (CN)

(72) Inventors: Weichao TANG, Guangdong (CN); Suli LI, Guangdong (CN); Wei ZHAO, Guangdong (CN)

(21) Appl. No.: 18/225,633

(22) Filed: Jul. 24, 2023

Related U.S. Application Data
(63) Continuation of application No. PCT/CN2022/081033, filed on Mar. 15, 2022.

(30) Foreign Application Priority Data
Mar. 15, 2021 (CN) 2021102780296

(51) Int. Cl. H01M 10/42; H01M 4/62; H01M 50/434

(52) U.S. Cl. CPC H01M 10/4235; H01M 4/62; H01M 50/434; H01M 2004/028

(57) ABSTRACT

The present disclosure provides a secondary battery, which includes an additive (a compound represented by Formula 1). The additive (compound represented by Formula 1) can be fully mixed with other components in the secondary battery due to its small molecular weight and short polymer segment. The additive (compound represented by Formula 1) is in a state of viscous liquid, semi-solid or solid at room temperature, which can fully contact each component and be immersed in internal pores. The additive of the present invention can form a film on the positive/negative electrode surface. The additive of the present disclosure can also participate in the film forming reaction of the positive and negative electrodes, and form a solid interfacial film structure with a certain molecular weight on the surfaces of the positive and negative electrodes.

### CROSS-REFERENCE TO RELATED APPLICATIONS

This application is a continuation of International Application No. PCT/CN2022/081033, filed on Mar. 15, 2022, which claims priority to Chinese Patent Application No. 202110278029.6, filed on Mar. 15, 2021, both of which are hereby incorporated by reference in their entireties.

### TECHNICAL FIELD

The present disclosure relates to the technical field of a secondary battery, in particular to a secondary battery containing an additive.

### BACKGROUND

The secondary battery is currently widely used in fields such as digital, electric vehicles, energy storage. The secondary battery mainly consists of a positive electrode, a negative electrode, a separator, and an electrolyte. The secondary battery will form an interfacial film between the positive electrode and the negative electrode during first charge and discharge. The composition of this interfacial film is complex, so that in actual use process, the structure of interfacial film may be unstable, resulting in continuous dissolution and generation of the components of the interfacial film on the positive and negative electrode surfaces. This further leads to the continuous consumption of solvents and adjuvants in the electrolyte, which aggravates side reactions on the positive electrode surface and the negative electrode surface of the secondary battery, increases internal resistance, and directly reduces the performance of secondary battery. Therefore, it is particularly important to form an efficient and stable interfacial film structure to improve the performance of battery.

### SUMMARY

In order to improve the disadvantages of the prior art, the present disclosure provides a secondary battery, in particular a secondary battery containing an additive. The addition of the additive can effectively improve the stability of an interfacial film on surfaces of the positive and negative electrodes in the secondary battery, and improve the cycling performance of secondary battery.

The object of the present disclosure is achieved through the following technical solutions.

A secondary battery includes an additive, and the additive is selected from at least one of compounds represented by Formula 1:

R₁—R-M-R′—R′₁ Formula 1

where, M is selected from polyphenylene oxide segment, polyethylene glycol segment, polyethylene dithiol segment, polycarbonate segment, polypropylene glycol segment or polysiloxane segment; R₁ and R′₁ are capping groups, and at least one of R₁ and R′₁ includes a carbon-carbon double bond or a carbon-carbon triple bond as end group; R and R′ are linking groups.

According to the present disclosure, the secondary battery includes a positive electrode plate, a negative electrode plate, a separator, and an electrolyte, and at least one of the positive electrode plate, the separator, and the electrolyte contains the additive.

The carbon-carbon double bond or carbon-carbon triple bond in the additive of the disclosure containing them undergoes electrochemical polymerization at low potential, and forms a stable and solid interfacial film on a surface of positive/negative electrode, effectively reducing occurrence of side reactions on the surfaces of positive and negative electrodes, lowering internal resistance increase during a battery cycling, and improving battery cycling performance.

The present disclosure also provides a battery pack, including the above secondary battery.

The present disclosure also provides an electronic device, including the above secondary battery.

The present disclosure also provides an electric vehicle, including the above secondary battery.

The present disclosure also provides an energy storage device, including the above secondary battery.

The beneficial effects of the present disclosure:

the present disclosure provides a secondary battery, which includes an additive (a compound represented by Formula 1). The additive (a compound represented by Formula 1) can be fully mixed with other components in the secondary battery due to its small molecular weight and short polymer segment. Moreover, the additive (compounds represented by Formula 1) is in a state of viscous liquid, semi-solid or solid at normal temperature, and can fully contact each component and immerse itself in internal pores. The additive of the present disclosure can form a film on the positive/negative electrode surface, which can effectively improve the increase in internal resistance during the cycling of positive and negative electrodes, and enhance the cycling life. The additive of the present disclosure can also participate in the film forming reaction of the positive and negative electrodes, form a solid interfacial film structure with a certain molecular weight on the surfaces of the positive and negative electrodes, improve the composition of the solid interfacial film on the surfaces of the positive and negative electrodes, increase the contents of high molecular components in the solid interfacial film, improve the conduction of electrons and lithium ions inside the secondary battery electrode plate, improve the lithium ion dynamics inside the electrode plate, and enhance the battery cycling performance.

### DESCRIPTION OF EMBODIMENTS

<Additive>

The secondary battery of the present disclosure includes an additive, and the additive is selected from at least one of compounds represented by Formula 1:

R₁—R-M-R′—R′₁ Formula 1

where, M is selected from polyphenylene oxide segment, polyethylene glycol segment, polyethylene dithiol segment, polycarbonate segment, polypropylene glycol segment or polysiloxane segment; R1 and R′1 are capping groups, and at least one of R₁ and R′₁ includes a carbon-carbon double bond or a carbon-carbon triple bond as an end group; R and R′ are linking groups.

In an embodiment of the present disclosure, R₁ and R′₁ are capping groups, and at least one of R₁ and R′₁ includes at least one of following groups as an end group: —O—(C═O)—C(R₂)═C(R′₂)(R′₂), —N(R₃)—(C═O)—C(R₂)═C(R′₂)(R′₂), —C(R₂)═C(R′₂)(R′₂), and —C≡C—R′₂; where R₂ is selected from H or organic functional groups (such as C₁₋₁₂ alkyl, C₃₋₂₀ cycloalkyl, 3-20 membered heterocyclic group, C₆₋₁₈ aryl group, 5-20 membered heteroaryl group, an bridge-ring group formed by C₃₋₂₀ cycloalkyl group and C₃₋₂₀ cycloalkyl group, bridge-ring group formed by C₃₋₂₀ cycloalkyl group and 3-20 membered heterocyclic group, and bridge-ring group formed by 3-20 membered heterocyclic group and 3-20 membered heterocyclic group); R′₂ is the same or different, and is independently selected from H or organic functional groups (such as C₁₋₁₂ alkyl group, C₃₋₂₀ cycloalkyl group, 3-20 membered heterocyclic group, C₆₋₁₈ aryl group, 5-20 membered heteroaryl group, bridge-ring group formed by C₃₋₂₀ cycloalkyl group and C₃₋₂₀ cycloalkyl group, bridge-ring group formed by C₃₋₂₀ cycloalkyl group and 3-20 membered heterocyclic group, and bridge-ring group formed by 3-20 membered heterocyclic group and 3-20 membered heterocyclic group); R₃ is selected from H or C₁₋₃ alkyl group.

In an embodiment of the present disclosure, one or both of R₁ and R′₁ include one or two of following groups as an end group: —O—(C═O)—C(R₂)═C(R′₂)(R′₂), —N(R₃)—(C═O)—C(R₂)═C(R′₂)(R′₂), —C(R₂)═C(R′₂)(R′₂), and —C≡C—R′2; where R₂ is selected from H or C₁₋₆ alkyl group (e.g. H or C₁₋₃ alkyl group; further e.g. H or methyl group); R′₂, which is the same or different, is independently selected from H or C₁₋₆ alkyl group (e.g. H or C₁₋₃ alkyl group; further e.g. H or methyl group); R₃ is selected from H or C₁₋₃ alkyl group.

In an embodiment of the present disclosure, R and R′, which are the same or different, are independently selected from alkylene and —NR₃—, if present; where R₃ is H or C₁₋₃ alkyl.

Preferably, R and R′ are the same or different, and are independently selected from —CH₂—, —CH₂CH₂—, —NH—, —N(CH₃)—, and —N(CH₂CH₃)—, if present.

In an embodiment of the present disclosure, the polyphenylene oxide segment has a repeating unit represented by Formula 2:

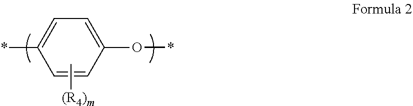

where, R₄ is selected from H or C₁₋₆ alkyl group, and m is an integer between 0 and 4. Exemplarily, R₄ is selected from H or C₁₋₃ alkyl group, and m is an integer between 0 and 2.

Specifically, the polyphenylene oxide segment has a repeating unit represented by Formula 2′:

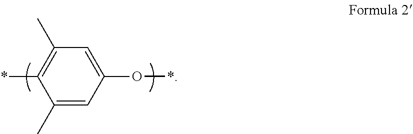

In an embodiment of the present disclosure, the polyethylene glycol segment has a repeating unit represented by Formula 3:

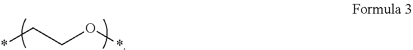

In an embodiment of the present disclosure, the polypropylene glycol segment has a repeating unit represented by Formula 4:

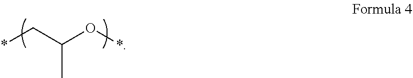

In an embodiment of the present disclosure, the polyethylene dithiol segment has a repeating unit represented by Formula 5:

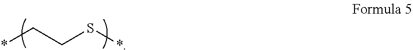

In an embodiment of the present disclosure, the polycarbonate segment has a repeating unit represented by Formula 6:

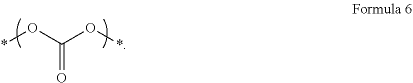

In an embodiment of the present disclosure, the polysiloxane segment has a repeating unit represented by Formula 7:

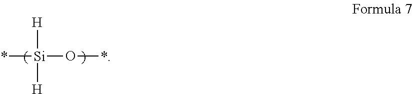

In an embodiment of the present disclosure, M has a number average molecular weight of 100-30000.

In an embodiment of the present disclosure, the compound represented by Formula 1 has a number average molecular weight of 200-30000, preferably, 300-10000.

In an embodiment of the present disclosure, the compound represented by Formula 1 is selected from at least one of polyethylene dithiol acrylate, polyethylene dithiol methacrylate, polyethylene dithiol diacrylate, polyethylene dithiol dimethacrylate, polyethylene dithiol phenyl ether acrylate, polyethylene dithiol mono allyl ether, polyethylene glycol acrylate, polyethylene glycol methacrylate, polyethylene glycol diacrylate, polyethylene glycol dimethacrylate, polyethylene glycol phenyl ether acrylate, polyethylene glycol mono allyl ether, polycarbonate acrylate, polycarbonate methacrylate, polycarbonate diacrylate, polycarbonate dimethacrylate, polycarbonate phenyl ether acrylate, polycarbonate mono allyl ether, polypropylene glycol acrylate, polypropylene glycol methacrylate, polypropylene glycol diacrylate, polypropylene glycol dimethacrylate, polypropylene glycol phenyl ether acrylate, polypropylene glycol mono allyl ether, polysiloxane acrylate, polysiloxane methacrylate, polysiloxane diacrylate, polysiloxane dimethacrylate, polysiloxane phenyl ether acrylate, and polysiloxane mono allyl ether.

Exemplarily, the additive is selected from at least one of compounds represented by Formulas 1-1, 1-2, 1-3, 1-4, 1-5, 1-6, 1-7, and 1-8:

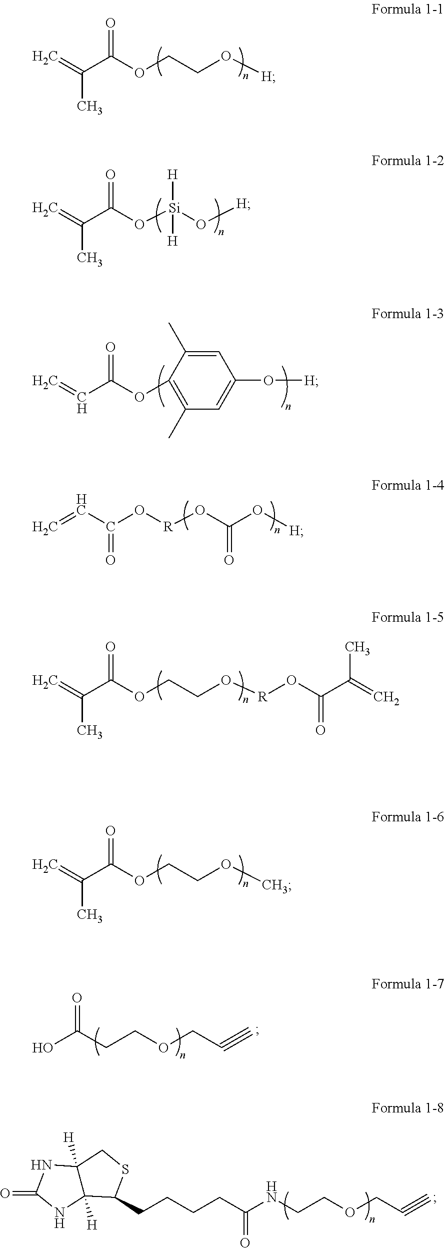

in Formulas 1-1 to 1-8, n is a number of the repeating unit, which is same or different among formulas; exemplarily, n is an integer between 2 and 680;
in Formulas 1-4 and 1-5, R is a linking group, as defined above.

A compound represented by Formula 1-7 is, for example, propargyl-PEG3-acetic acid (CAS: 1415800-32-6); a compound represented by Formula 1-8 is, for example, biotin-PEG4-alkyne (CAS: 1262681-31-1).

In the present disclosure, the additive may be obtained by the conventional preparation methods in the art or through purchase from commercial sources.

<Negative Electrode Plate>

In an embodiment of the present disclosure, the secondary battery includes a negative electrode plate, and the negative electrode plate includes the aforementioned additive.

Specifically, the negative electrode plate includes a negative current collector and a negative active substance layer coated on one- or both-side surfaces of the negative current collector. The negative active substance layer includes a negative active substance, a conductive agent, a binder, and the aforementioned additive.

At this point, the carbon-carbon double bond or the carbon-carbon triple bond in the additive containing carbon-carbon double bond or carbon-carbon triple bond of the disclosure will undergo electrochemical polymerization at low potential, and form a stable solid interfacial film on a surface of the negative electrode, effectively reducing occurrence of side reactions on the surface of the negative electrode, reducing internal resistance increase during battery cycling, and improving battery cycling performance.

In an embodiment of the present disclosure, the negative active substance layer includes components with following mass percentage content: 75-98 wt % of negative active substance, 1-15 wt % of conductive agent, 0.999-10 wt % of binder, and 0.001-2 wt % of aforementioned additive.

Exemplarily, an addition amount of the negative active substance accounts for 75 wt % 76 wt %, 77 wt % 78 wt %, 79 wt %, 80 wt %, 81 wt %, 82 wt %, 83 wt %, 84 wt % 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, and 98 wt % of a total mass of the negative active substance layer.

Exemplarily, an addition amount of the additive accounts for 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, and 15 wt % of the total mass of the negative active substance layer.

Exemplarily, an addition amount of the additive accounts for 0.001 wt %, 0.05 wt %, 0.1 wt %, 0.15 wt %, 0.25 wt %, 0.55 wt, 0.65 wt %, 0.70 wt %, 0.75 wt %, 0.85 wt %, 0.90 wt %, 1.0 wt %, 1.2 wt %, 1.5 wt %, and 2 wt %% of the total mass of the negative active substance layer. When the content of the additive is greater than 2 wt %, excessive additive may lead to a decrease in content of negative active substance, resulting in low capacity of electrode plate and poor conductive network of lithium ions and electrons inside the electrode plate, affecting battery performance and thus not meeting application conditions; and when the content of the additive is less than 0.001 wt %, the content of the additive is too low, so that film forming property is poor and the formed solid interfacial film structure on the surface of the negative electrode is unstable, which reduces the battery performance.

Exemplarily, an addition amount of the binder accounts for 0.999 wt %, 1 wt %, 2 wt %, 3 wt %, 4 wt %, 5 wt %, 6 wt %, 7 wt %, 8 wt %, 9 wt %, and 10 wt % of the total mass of the negative active substance layer.

In an embodiment of the present disclosure, the negative active substance is selected from a silicon-based material and/or a carbon-based material.

The carbon-based material is selected from at least one of artificial graphite, natural graphite, hard carbon, soft carbon, meso carbon microbcad, fullerene, and graphene.

The silicon-based material is selected from at least one of nano silicon, SiOx (0<x<2), aluminum-silicon alloy, magnesium-silicon alloy, boron-silicon alloy, phosphorus-silicon alloy, and lithium-silicon alloy.

In an embodiment of the present disclosure, the conductive agent is selected from one or more of conductive carbon black, Ketjen black, conductive fiber, conductive polymer, acetylene black, carbon nanotube, graphene, flake graphite, conductive oxide and metal particle.

In an embodiment of the present disclosure, the binder is selected from at least one of polyvinylidene fluoride and its copolymer derivatives, polytetrafluoroethylene and its copolymer derivatives, polyacrylic acid and its copolymer derivatives, polyvinyl alcohol and its copolymer derivatives, polybutadiene styrene rubber and its copolymer derivatives, polyimide and its copolymer derivatives, polyethylenimine and its copolymer derivatives, polyacrylate and its copolymer derivatives, sodium carboxymethyl cellulose and its copolymer derivatives.

In an embodiment of the present disclosure, the negative electrode plate has an areal density of 0.2-25 mg/cm².

In an embodiment of the present disclosure, a thickness of the negative active substance layer (one-side thickness of rolled negative active substance layer) is 20 μm-200 μm, preferably 30 μm-150 μm, such as 20 μm, 25 μm, 30 μm, 35 μm, 40 μm, 45 μm, 50 μm, 55 μm, 60 μm, 70 μm, 80 μm, 90 μm, 100 μm, 110 μm, 120 μm, 130 μm, 140 μm, 150 μm, 160 μm, 170 μm, 180 μm, 190 μm or 200 μm.

<A Method for Preparing a Negative Electrode Plate>

The present disclosure also provides a method for preparing the above negative electrode plate, and the method includes the following steps:

mixing a solvent, a negative active substance, a conductive agent, a binder, and at least one compound represented by Formula 1 uniformly to prepare a negative electrode slurry; coating the negative electrode slurry on a surface of negative current collector; and drying to obtain the negative electrode plate.

In an embodiment of the present disclosure, the negative electrode slurry contains 100-650 parts by mass of solvent, 75-98 parts by mass of negative active substance, 1-15 parts by mass of conductive agent, 0.001-2 parts by mass of at least one compound represented by Formula 1, and 0.999-10 parts by mass of binder.

In an embodiment of the present disclosure, the solvent is selected from at least one of water, acetonitrile, benzene, toluene, xylene, acetone, tetrahydrofuran, hydrofluoroether, and N-methylpyrrolidone.

In an embodiment of the present disclosure, the negative electrode slurry is preferably a sieved negative electrode slurry, such as a slurry through a 200-mesh sieve.

In an embodiment of the present disclosure, a drying temperature is 50° C.-110° C., and a drying time is 6-36 hours.

<Positive Electrode Plate>

In an embodiment of the present disclosure, the secondary battery includes a positive electrode plate, which includes the aforementioned additive.

Specifically, the positive electrode plate includes a positive current collector and a positive active substance layer coated on one- or both-side surfaces of the positive current collector. The positive active substance layer includes a positive active substance, a conductive agent, a binder, and the aforementioned additive.

At this point, the carbon-carbon double bond or the carbon-carbon triple bond in the additive containing carbon-carbon double bond or carbon-carbon triple bond of the disclosure will undergo electrochemical polymerization at low potential, and form a stable solid interfacial film on a surface of the positive electrode, effectively reducing occurrence of side reactions on the surface of the positive electrode, reducing internal resistance increase during battery cycling, and improving battery cycling performance.

In an embodiment of the present disclosure, the positive active substance layer includes components with following mass percentage content: 80-98.5 wt % of positive active substance, 0.5-10 wt % of conductive agent, 0.5-5 wt % of binder, and 0.001-5 wt % of aforementioned additive.

Exemplarily, an addition amount of the positive active substance accounts for 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, or 98.5 wt % of a total mass of the positive active substance layer.

Exemplarily, an addition amount of the conductive agent accounts for 0.5 wt %, 1 wt %, 2 wt %, 3 wt %, 4 wt %, 5 wt %, 6 wt %, 7 wt %, 8 wt %, 9 wt %, or 10 wt % of the total mass of the positive active substance layer.

Exemplarily, an addition amount of the additive accounts for 0.001 wt %, 0.05 wt %, 0.1 wt %, 0.15 wt %, 0.25 wt %, 0.55 wt %, 0.65 wt %, 0.70 wt %, 0.75 wt %, 0.85 wt %, 0.90 wt %, 1.0 wt %, 1.2 wt %, 1.5 wt %, 2 wt %, 3 wt %, 4 wt %, or 5 wt % the total mass of the positive active substance layer. When the content of the additive is greater than 5 wt %, excessive additive may lead to a decrease in content of positive active substance, resulting in low capacity of electrode plate and poor conductive network of lithium ions and electrons inside the electrode plate, affecting battery performance and thus not meeting application conditions; and when the content of the additive is less than 0.001 wt %, the content of the additive is too low, so that the film forming property is poor and the formed interfacial film structure on the surface of the positive electrode is unstable, which reduces the battery performance.

Exemplarily, an addition amount of the binder accounts for 0.5 wt %, 1 wt %, 2 wt %, 3 wt %, 4 wt %, and 5 wt % of the total mass of the positive active substance layer.

In an embodiment of the present disclosure, the positive active substance is selected from one or more of ferrous lithium phosphate, nickel cobalt manganese material, nickel cobalt aluminum material, lithium cobaltate, lithium manganate, and lithium-rich manganese based material.

In an embodiment of the present disclosure, the conductive agent is selected from one or more of conductive carbon black, Ketjen black, conductive fiber, conductive polymer, acetylene black, carbon nanotube, graphene, flake graphite, conductive oxide and metal particle.

In an embodiment of the present disclosure, the binder is selected from at least one of polyvinylidene fluoride and its copolymer derivatives, polytetrafluoroethylene and its copolymer derivatives.

In an embodiment of the present disclosure, the positive electrode plate has an areal density of 5-25 mg/cm².

In an embodiment of the present disclosure, a thickness of the positive active substance layer (one-side thickness of rolled positive active substance layer) is 10 μm-150 μm, preferably 50 μm-100 μm, such as 10 μm, 25 μm, 30 μm, 35 μm, 40 μm, 45 μm, 50 μm, 55 μm, 60 μm, 70 μm, 80 μm, 90 μm, 100 μm, 110 μm, 120 μm, 130 μm, 140 μm, and 150 μm.

<A Method for Preparing a Positive Electrode Plate>

The present disclosure also provides a method for preparing the above positive electrode plate, and the method includes the following steps:

mixing a solvent, a positive active substance, a conductive agent, a binder, and at least one compound represented by Formula 1 uniformly to prepare a positive electrode slurry; coating the positive electrode slurry on a surface of positive current collector; and drying to obtain the positive electrode plate.

In an embodiment of the present disclosure, the positive electrode slurry contains 200-600 parts by mass of solvent, 80-98.5 parts by mass of positive active substance, 0.5-10 parts by mass of conductive agent, 0.001-5 parts by mass of at least one compound represented by Formula 1, and 0.5-5 parts by mass of binder.

In an embodiment of the present disclosure, the solvent is selected from at least one of benzene, toluene, xylene, acetone, tetrahydrofuran, hydrofluoroether, and N-methylpyrrolidone.

In an embodiment of the present disclosure, the positive electrode slurry is preferably a sieved positive electrode slurry, such as a slurry through a 200-mesh sieve.

In an embodiment of the present disclosure, a drying temperature is 90° C.-120° C., and a drying time is 12-48 hours.

<Separator>

In an embodiment of the present disclosure, the secondary battery includes a separator, which includes the aforementioned additive.

Specifically, the separator includes a separator substrate and a composite layer coated on one- or both-side surfaces of the separator substrate, where the composite layer includes a binder, the aforementioned additive, and in an implementation, the composite layer further includes a ceramic.

At this point, the carbon-carbon double bond or the carbon-carbon triple bond in the additive containing carbon-carbon double bond or carbon-carbon triple bond of the disclosure will undergo electrochemical polymerization at low potential, and form a stable solid interfacial film on surfaces of the positive electrode and the negative electrode, effectively reducing occurrence of side reactions on the surface of the negative electrode, reducing internal resistance increase during battery cycling, and improving battery cycling performance.

In an embodiment of the present disclosure, the composite layer includes components with following mass percentage content: the ceramic: 0-50 wt % of ceramic, 40-90 wt % of binder, and 0.1-10 wt % of aforementioned additive.

Exemplarily, an addition amount of the ceramic accounts for 0 wt %, 1 wt %, 2 wt %, 3 wt %, 4 wt %, 5 wt %, 8 wt %, 9 wt %, 13 wt %, 15 wt %, 20 wt %, 21 wt %, 23 wt %, 25 wt %, 26 wt %, 27 wt %, 28 wt %, 30 wt %, 35 wt %, 41 wt %, 43 wt %, 45 wt %, or 50 wt % of a total mass of the composite layer.

Exemplarily, an addition amount of the binder accounts for 40 wt %, 45 wt %, 50 wt %, 55 wt %, 60 wt %, 65 wt %, 70 wt %, 75 wt %, 80 wt %, 85 wt %, or 90 wt % of the total mass of the composite layer.

Exemplarily, an addition amount of the additive accounts for 0.1 wt %, 0.5 wt %, 1 wt %, 1.5 wt %, 2 wt % 2.5 wt %, 3 wt % 3.5 wt %, 4 wt % 4.5 wt %, 5 wt %, 5.5 wt %, 6 wt %, 6.5 wt %, 7 wt %, 7.5 wt %, 8.5 wt %, 9 wt %, or 10.0 wt % of the total mass of the composite layer. When the content of the additive is greater than 10 wt %, excessive additive may lead to a decrease in bonding performance of the composite layer of the separator, affecting battery performance and thus not meeting application conditions; and when the content of the additive is less than 0.1 wt %, the content of the additive is too low, so that the content of the additive in the composite layer on the separator surface is too low, which directly affects film-forming effect for the positive electrode and the negative electrode, thereby forming too few new interfacial film structures on surfaces, and reducing the battery performance.

In an embodiment of the present disclosure, the composite layer (one-side) has a thickness of 0.5-5 μm.

In an embodiment of the disclosure, the separator substrate is selected from at least one of polyethylene, polypropylene, polyethylene terephthalate, polybutylene terephthalate, polystyrene, polymer of naphthalene system, polyimide, polyamide, aramid, and poly(p-phenylene benzodiazole).

In an embodiment of the disclosure, the ceramic is selected from one or more of silicon dioxide, aluminum oxide, zirconium dioxide, magnesium hydroxide, boehmite, barium sulfate, fluorophlogopite, fluorapatite, mullite, cordierite, aluminum titanate, titanium dioxide, copper oxide, zinc oxide, boron nitride, aluminum nitride, magnesium nitride, and attapulgite.

In an embodiment of the present disclosure, the binder is selected from at least one of polyvinylidene fluoride and its copolymer derivatives, polytetrafluoroethylene and its copolymer derivatives, polyacrylic acid and its copolymer derivatives, polyvinyl alcohol and its copolymer derivatives, polybutadiene styrene rubber and its copolymer derivatives, polyimide and its copolymer derivatives, polyethylenimine and its copolymer derivatives, polyacrylate and its copolymer derivatives, sodium carboxymethyl cellulose and its copolymer derivatives.

<A Method for Preparing a Separator>

The present disclosure also provides a method for preparing the above separator, and the method includes the following steps:

mixing 0-50 parts by mass of ceramic, 40-90 parts by mass of binder, 0.1-10 parts by mass of the aforementioned additive, and 100-500 parts by mass of solvent uniformly to obtain a mixture, then coating the mixture to a surface of a separator substrate; and drying to obtain the separator.

In an embodiment of the present disclosure, the solvent is selected from at least one of water, acetonitrile, benzene, toluene, xylene, and acetone.

<Electrolyte>

In an embodiment of the present disclosure, the secondary battery includes an electrolyte, which includes the aforementioned additive.

Specifically, the electrolyte includes a non-aqueous organic solvent, a lithium salt, and the aforementioned additive.

At this point, the carbon-carbon double bond or the carbon-carbon triple bond in the additive containing carbon-carbon double bond or carbon-carbon triple bond of the disclosure will undergo electrochemical polymerization at low potential, and form a stable solid interfacial film on surfaces of the positive electrode and the negative electrode, effectively reducing occurrence of side reactions on the surface of the negative electrode, reducing internal resistance increase during battery cycling, and improving battery cycling performance.

In an embodiment of the disclosure, the lithium salt is selected from at least one of lithium hexafluorophosphate, lithium tetrafluoroborate, lithium bis(oxalato)borate, lithium difluoro(oxalato)borate, lithium difluoro(dioxalato) phosphate, lithium tetrafluoro(oxalato) phosphate, lithium difluorophosphate, lithium perchlorate, lithium difluorosulfonamide, and lithium bis(trifluoromethyl) sulfonimide.

In an embodiment of the present disclosure, the content of the lithium salt accounts for 12-18 wt %, such as 12 wt %, 12.5 wt %, 13 wt %, 13.5 wt %, 14 wt %, 14.5 wt %, 15 wt %, 15.5 wt %, 16 wt %, 16.5 wt %, 17 wt %, 17.5 wt %, and 18 wt % of a total mass of the electrolyte.

In an embodiment of the present disclosure, the non-aqueous organic solvent is selected from a mixture of at least one of cyclic carbonate and at least one of linear carbonate and linear carboxylate in any mixing proportion.

Preferably, the cyclic carbonate is selected from at least one of ethylene carbonate and propylene carbonate; the linear carbonate is selected from at least one of dimethyl carbonate, diethyl carbonate and methyl ethyl carbonate; and the linear carboxylate is selected from at least one of ethyl propionate, propyl propionate and propyl acetate.

In an embodiment of the present disclosure, based on a total mass of 100 wt %, the cyclic carbonate has a mass fraction of 10-50 wt % and the linear carbonate and/or linear carboxylate has a mass fraction of 50-90 wt % relative to the total mass of the electrolyte.

In an embodiment of the present disclosure, the content of the additive accounts for 0.01-5 wt % of the total mass of the electrolyte. When the content of the additive is higher than 5 wt %, excessive additive will increase the viscosity of the electrolyte, leading to poor wettability of the electrolyte, and meanwhile a lot of additive is complexed on the surfaces of the positive electrode and negative electrode, preventing lithium ions in the positive electrode and negative electrode from being detached from the active substance into the electrolyte. Thus excessive additive may result in a higher impedance Rsei, and is easy to lead to relative high impedance of the solid interfacial film on the surfaces of the positive electrode and negative electrode, which has great resistance to the detaching of lithium ions on the interfaces of the positive electrode and negative electrode, thus causing rapid performance degradation.

<A Method for Preparing an Electrolyte>

The present disclosure also provides a method for preparing the above electrolyte, and the method includes the following steps:

mixing a non-aqueous organic solvent, a lithium salt, and the aforementioned additive, and preparing to obtain the electrolyte.

The present disclosure will be further described in detail below in combination with specific examples. It should be understood that the following examples are only exemplarily illustrate and explain the present disclosure, and should not be interpreted as a limitation on the protection scope of the present disclosure. All technologies realized based on the above contents of the present disclosure are covered in the protection scope of the present disclosure.

Unless otherwise specified, the experimental methods used in the following examples are all conventional methods; and reagents, materials, and the like used in the following examples can be obtained from commercial sources unless otherwise specified.

### Example 1

1) Preparation of Positive Electrode Plate

95 g of lithium cobaltate as a positive active substance, 2 g of polyvinylidene fluoride (PVDF) as a binder, 2 g of conductive carbon black as a conductive agent, 1 g of carbon nanotube as a conductive agent were mixed, 400 g of N-methylpyrrolidone (NMP) was added and stirred under the action of a vacuum mixer until the mixed system became a positive electrode slurry with uniform fluidity; the positive electrode slurry was coated evenly on an aluminum foil with a thickness of 12 μm; after drying at 100° C. for 36 hours, the coated aluminum foil was vacuumized to obtain an electrode plate; and the electrode plate was rolled, and then cut to obtain the positive electrode plate.

2) Preparation of Negative Electrode Plate

75 g of SiO, 5 g of single-walled carbon nanotube (SWCNT) as a conductive agent, 10 g of conductive carbon black (SP) as a conductive agent, 2 g of polyethylene glycol methyl methacrylate, 4 g of sodium carboxymethyl cellulose (CMC) as a binder, 4 g of styrene butadiene rubber (SBR) as a binder, and 500 g of deionized water were prepared into a slurry using a wet process. The slurry was coated on a surfaces of a copper foil for negative current collector, and then the coated copper foil was dried, rolled and die-cut, to obtain the negative electrode plate.

3) Preparation of Electrolyte

In a glove box filled with argon gas where water and oxygen contents were qualified, ethylene carbonate, propylene carbonate, diethyl carbonate and n-propyl propionate were mixed in a proportion of 20:10:15:55 by mass to be uniform, then 1 mol/L of fully dried lithium hexafluorophosphate (LiPF₆) was quickly added into the mixture, stirred evenly, to obtain the electrolyte.

4) Separator

20 g of aluminum oxide, 20 g of polyvinylidene fluoride-hexafluoropropylene, and 200 g of acetone were mixed uniformly, then coated on a surface of a polyethylene separator substrate, and dried, to obtain the separator.

5) Preparation of Lithium Ion Battery

The positive electrode plate, the negative electrode plate, and the separator obtained above were used to prepare a cell of lithium ion battery, which was injected with the electrolyte, encapsulated and welded, to obtain the lithium ion battery.

### Comparative Example 1.1

A specific process of Comparative example 1.1 refers to Example 1, and the main difference between them is that in Comparative example 1.1, poly(polyethylene glycol methyl methacrylate) was used in the same mass as polyethylene glycol methyl methacrylate monomer of Example 1, where the poly(polyethylene glycol methyl methacrylate) was made from polyethylene glycol methyl methacrylate and azodiisobutyronitrile that have the same mass by full polymerization at 60° C., and then added into Comparative example 1.1 when a C═C double bond peak cannot be detected by infrared detection for the obtained polymer. Other conditions are consistent with Example 1.

### Comparative Example 1.2

A specific process of Comparative example 1.2 refers to Example 1. All other conditions are consistent with Example 1, except that polyethylene glycol methyl methacrylate monomer was not added in Comparative example 1.2.

### Example 2-6 and Other Comparative Examples

Specific processes of Examples 2-6 and other Comparative examples refer to Example 1. Main differences are the process condition of the negative electrode plate, the addition amount of each component, and the type of material for each component. Specific details are shown in Tables 1 and 2.

TABLE 1
Composition of negative electrode plates for Examples and Comparative examples

| | | Negative | | Polymer or | | Drying | |
|---|---|---|---|---|---|---|---|
| | | active | Conductive | monomer | | temperature | Drying |
| No. | Solvent/g | substance/g | agent/g | thereof/g | Binder/g | (° C.) | time (h) |
| Example 1 | 500 | 75 | 15 | 2 | 8 | 99 | 26 |
| Comparative | 500 | 75 | 15 | 2 | 8 | 99 | 26 |
| example 1.1 | | | | | | | |
| Comparative | 500 | 75 | 15 | — | 8 | 99 | 26 |
| example 1.2 | | | | | | | |
| Example 2 | 100 | 98 | 1 | 0.001 | 0.999 | 103 | 30 |
| Comparative | 100 | 98 | 1 | 0.001 | 0.999 | 103 | 30 |
| example 2.1 | | | | | | | |
| Comparative | 100 | 98 | 1 | — | 0.999 | 103 | 30 |
| example 2.2 | | | | | | | |
| Example 3 | 420 | 88 | 6 | 2 | 4 | 95 | 32 |
| Comparative | 420 | 88 | 6 | 2 | 4 | 95 | 32 |
| example 3.1 | | | | | | | |
| Comparative | 420 | 88 | 6 | — | 4 | 95 | 32 |
| example 3.2 | | | | | | | |
| Example 4 | 560 | 90.5 | 6 | 1.5 | 2 | 90 | 24 |
| Comparative | 560 | 90.5 | 6 | 1.5 | 2 | 90 | 24 |
| example 4.1 | | | | | | | |
| Comparative | 560 | 90.5 | 6 | — | 2 | 90 | 24 |
| example 4.2 | | | | | | | |
| Example 5 | 550 | 89 | 7.5 | 0.5 | 3 | 105 | 20 |
| Comparative | 550 | 89 | 7.5 | 0.5 | 3 | 105 | 20 |
| example 5.1 | | | | | | | |
| Comparative | 550 | 89 | 7.5 | — | 3 | 105 | 20 |
| example 5.2 | | | | | | | |
| Example 6 | 650 | 98 | 0.5 | 0.2 | 1.3 | 85 | 36 |
| Comparative | 650 | 98 | 0.5 | 0.2 | 1.3 | 85 | 36 |
| example 6.1 | | | | | | | |
| Comparative | 650 | 98 | 0.5 | — | 1.3 | 85 | 36 |
| example 6.2 | | | | | | | |

TABLE 2
Composition of negative electrode plates for Examples and Comparative examples

| | Negative | | | |
|---|---|---|---|---|
| | active | Conductive | | |
| No. | substance | agent | Polymer monomer/polymer | Binder |
| Example 1 | SiO | Conductive | Polyethylene glycol methyl methacrylate | Carboxymethyl |
| | | carbon | (molecular weight of monomer 300) | cellulose + SBR(1:1) |
| Comparative | | black + | Poly (polyethylene glycol methyl | |
| example 1.1 | | carbon | methacrylate) | |
| Comparative | | nanotube | — | |
| example 1.2 | | (2:1) | | |
| Example 2 | SiO + | Conductive | Polyphenylene oxide acrylate (molecular | Carboxymethyl |
| | graphite | carbon | weight of monomer 500) | cellulose + |
| Comparative | (1:8) | black | Poly (polyphenylene oxide acrylate) | polypropylene- |
| example 2.1 | | | | acrylate rubber (1:1.2) |
| Comparative | | | — | |
| example 2.2 | | | | |
| Example 3 | Graphite + | Conductive | Polycarbonate acrylate (molecular weight | Polyacrylate + |
| | SiO | fiber + | of monomer 1500) | polybutadiene styrene |
| Comparative | (9:1) | carbon | Poly (polycarbonate acrylate) | rubber (1:1.3) |
| example 3.1 | | nanotube | | |
| Comparative | | (1:1) | — | |
| example 3.2 | | | | |
| Example 4 | Graphite + | Carbon | Polyethylene glycol methyl methacrylate | Carboxymethyl |
| | silicon | nanotube + | (molecular weight of monomer 1000) | cellulose + |
| Comparative | (10:1) | graphene | Poly (polyethylene glycol methyl | polybutadiene styrene |
| example 4.1 | | (1:2) | methacrylate) | rubber (1:1) |
| Comparative | | | — | |
| example 4.2 | | | | |
| Example 5 | Hard | Conductive | Polysiloxane methyl methacrylate | Polyacrylate + |
| | carbon + | carbon | (molecular weight of monomer 600) | polyacrylate (1.5:1) |
| Comparative | graphite | black + | Poly (polysiloxane methyl methacrylate) | |
| example 5.1 | (1:8) | carbon | | |
| Comparative | | nanotube | — | |
| example 5.2 | | (2:1) | | |
| Example 6 | Graphite | Carbon | Polyethylene glycol methyl | Carboxymethyl |
| | | nanotube | dimethylacrylate (molecular weight of | cellulose + |
| | | | monomer 1000) | polybutadiene styrene |
| Comparative | | | Poly (polyethylene glycol methyl | rubber (1:1) |
| example 6.1 | | | dimethylacrylate) | |
| Comparative | | | — | |
| example 6.2 | | | | |

Where, the proportions in parentheses, unless otherwise specified, are all mass ratios. For example, the meaning of conductive carbon black + carbon nanotube (2:1) is that the mass ratio of conductive carbon black to carbon nanotube is (2:1).

Performance tests were conducted for the batteries prepared in the above examples and comparative examples.

(1) Alternating current impedance test method for battery internal resistance: Metrohm PGSTAT302N chemical workstation is used for alternating current impedance test on lithium ion battery of 50% SOC in a range of 100 K4 Hz to 0.1 mHz at 25° C. The test results are listed in Table 3.

TABLE 3
Results of alternating current impedance test of battery
internal resistance for examples and comparative examples

| | Battery | Battery | Battery | Battery |
|---|---|---|---|---|
| | internal | internal | internal | internal |
| | resistance | resistance | resistance | resistance |
| | after 100 | after 200 | after 300 | after 400 |
| No. | cycles (mΩ) | cycles (mΩ) | cycles (mΩ) | cycles (mΩ) |
| Example 1 | 13.15 | 20.33 | 27.44 | 34.89 |
| Comparative | 16.25 | 24.84 | 33.52 | 42.61 |
| example 1.1 | | | | |
| Comparative | 18.46 | 27.28 | 38.19 | 49.11 |
| example 1.2 | | | | |
| Example 2 | 6.21 | 13.57 | 20.82 | 28.28 |
| Comparative | 8.52 | 16.13 | 24.53 | 32.84 |
| example 2.1 | | | | |
| Comparative | 10.81 | 19.25 | 28.54 | 37.34 |
| example 2.2 | | | | |
| Example 3 | 4.22 | 11.32 | 18.51 | 25.72 |
| Comparative | 5.35 | 13.26 | 21.34 | 29.39 |
| example 3.1 | | | | |
| Comparative | 6.32 | 16.01 | 25.58 | 35.36 |
| example 3.2 | | | | |
| Example 4 | 5.61 | 14.68 | 23.91 | 33.11 |
| Comparative | 7.65 | 18.82 | 30.01 | 41.24 |
| example 4.1 | | | | |
| Comparative | 8.72 | 22.61 | 36.53 | 50.51 |
| example 4.2 | | | | |
| Example 5 | 12.44 | 19.21 | 26.01 | 32.81 |
| Comparative | 15.35 | 23.43 | 31.40 | 39.72 |
| example 5.1 | | | | |
| Comparative | 19.09 | 28.19 | 37.38 | 46.69 |
| example 5.2 | | | | |
| Example 6 | 2.25 | 20.31 | 27.53 | 22.77 |
| Comparative | 3.31 | 25.02 | 33.73 | 26.53 |
| example 6.1 | | | | |
| Comparative | 4.61 | 28.58 | 38.79 | 33.57 |
| example 6.2 | | | | |

### Example 6.2

The results of the internal resistance tests during the cycling of battery indicate that the lithium ion batteries prepared in the Examples of the present disclosure have an internal resistance smaller than that of the lithium ion batteries prepared in the Comparative examples during cycling. The main reason is that the additive added in the disclosure can form a solid interfacial film on the surface of the negative electrode material. Such solid interfacial film is different from a solid interfacial film on a surface of a conventional negative electrode material; has functional characteristics of high content of polymer component, large molecular weight, and high speed lithium ion conduction, and the like; and can quickly conduct lithium ions, so that the prepared lithium ion battery has lower internal resistance. Meanwhile, the internal resistance of the lithium ion battery increases less during cycling, which has good application prospects.

(2) Test method for battery cycling performance: a charge and discharge cycling test for lithium ion battery is conducted on a battery charge and discharge test cabinet (from LANHE), with the test conditions of 25° C., 0.5 C/0.5 C charge and discharge. The test results are listed in Table 4.

TABLE 4
Results of battery cycling performance tests
in Examples and Comparative examples

| | Battery | Battery | Battery | Battery |
|---|---|---|---|---|
| | capacity | capacity | capacity | capacity |
| | retention | retention | retention | retention |
| | ratio after | ratio after | ratio after | ratio after |
| | 100 cycles | 300 cycles | 500 cycles | 700 cycles |
| No. | (%) | (%) | (%) | (%) |
| Example 1 | 98.41 | 93.13 | 87.78 | 82.62 |
| Comparative | 97.51 | 91.12 | 84.65 | 78.52 |
| example 1.1 | | | | |
| Comparative | 96.43 | 88.31 | 80.20 | 72.38 |
| example 1.2 | | | | |
| Example 2 | 98.91 | 94.24 | 89.74 | 85.31 |
| Comparative | 97.86 | 92.61 | 87.53 | 82.43 |
| example 2.1 | | | | |
| Comparative | 97.21 | 91.22 | 85.31 | 79.51 |
| example 2.2 | | | | |
| Example 3 | 97.85 | 92.44 | 86.86 | 81.32 |
| Comparative | 96.54 | 90.94 | 85.12 | 79.45 |
| example 3.1 | | | | |
| Comparative | 95.13 | 88.45 | 81.86 | 75.25 |
| example 3.2 | | | | |
| Example 4 | 96.63 | 90.85 | 85.03 | 79.43 |
| Comparative | 95.22 | 88.52 | 81.61 | 75.26 |
| example 4.1 | | | | |
| Comparative | 94.13 | 86.12 | 78.13 | 70.12 |
| example 4.2 | | | | |
| Example 5 | 95.44 | 91.37 | 87.63 | 83.81 |
| Comparative | 94.31 | 89.71 | 85.56 | 81.14 |
| example 5.1 | | | | |
| Comparative | 93.25 | 88.16 | 83.17 | 78.28 |
| example 5.2 | | | | |
| Example 6 | 98.81 | 93.13 | 87.81 | 89.82 |
| Comparative | 98.26 | 91.03 | 84.45 | 88.37 |
| example 6.1 | | | | |
| Comparative | 97.45 | 88.42 | 80.44 | 86.22 |
| example 6.2 | | | | |

The cycling performance test results of the Examples and the Comparative examples show: the capacity retention rate of the lithium ion batteries prepared in the Examples of the present disclosure is higher than that of the lithium ion batteries prepared in the Comparative examples during cycling. The main reason is that the additive added in the disclosure can form a solid interfacial film on the surface of the negative electrode material. Such solid interfacial film is different from a solid interfacial film on the surface of the conventional negative electrode material, has functional characteristics of high content of polymer component, large molecular weight, high-speed lithium ion conduction, and the like. The solid interfacial film on the surface of conventional negative electrode material reacts on the negative electrode along with lithium ions conduction during battery cycling, some solid interfacial components of the solid interfacial film are dissolved, and more new interfaces are generated at the same time. The new interfaces consume the electrolyte and lithium salt, which will reduce the battery performance. In the disclosure, due to the addition of the additive, a more stable solid interfacial film with higher lithium ion conductivity can be formed on the surface of the negative electrode material, which can greatly improve the cycling performance of the secondary battery.

The cycling charge and discharge test results of the Examples and the Comparative examples show: the negative electrode plate prepared by the present disclosure has low internal resistance during cycling, and there are good lithium ion and electron conducting channels inside the negative electrode plate, which makes the prepared lithium ion battery have good cycling performance.

### Example 7

1) Preparation of Positive Electrode Plate

95 g of lithium cobaltate as a positive active substance, 0.5 g of polyvinylidene fluoride (PVDF) as a binder, 0.5 g of carbon black as a conductive agent, 0.5 g of polyethylene glycol methyl methacrylate (molecular weight of monomer 300) were mixed, 400 g of N-methylpyrrolidone (NMP) was added and stirred under the action of a vacuum mixer until the mixed system became a positive electrode slurry with uniform fluidity; the positive electrode slurry was coated evenly on an aluminum foil with a thickness of 12 μm; after drying at 100° C. for 36 hours, the coated aluminum foil was vacuumized to obtain an the electrode plate; and the electrode plate was rolled, and then cut to obtain the positive electrode plate.

2) Preparation of Negative Electrode Plate

97 g of graphite, 0.5 g of single-walled carbon nanotube (SWCNT) as a conductive agent, 0.5 g of conductive carbon black (SP) as a conductive agent, 1 g of sodium carboxymethyl cellulose (CMC) as a binder, 1 g of styrene butadiene rubber (SBR) as a binder, and 500 g of deionized water were prepared into a slurry using a wet process. The slurry was coated on a surface of a copper foil for a negative current collector, and then the coated copper foil was dried, rolled and die-cut, to obtain the negative electrode plate.

3) Preparation of Electrolyte

In a glove box filled with argon gas where water and oxygen contents were qualified, ethylene carbonate, propylene carbonate, diethyl carbonate and n-propyl propionate were mixed in a proportion of 20:10:15:55 by mass ratio to be uniform, then 1 mol/L of fully dried lithium hexafluorophosphate (LiPF₆) was quickly added into the mixture, and stirred evenly, to obtain the electrolyte.

4) Separator

30 g of aluminum oxide, 20 g of polyvinylidene fluoride-hexafluoropropylene, and 200 g of acetone were mixed uniformly, then coated on a surface of a polyethylene separator substrate, and dried, to obtain the separator.

5) Preparation of Lithium Ion Battery

The positive electrode plate, the negative electrode plate, and the separator obtained above were used to prepare a cell of lithium ion battery, which was injected with the electrolyte, encapsulated and welded, to obtain the lithium ion battery.

### Comparative Example 7.1

A specific process of Comparative example 7.1 refers to Example 7, and the main difference between them is that in Comparative example 7.1, poly(polyethylene glycol methyl methacrylate) was used in the same mass as polyethylene glycol methyl methacrylate monomer of Example 7, where the poly(polyethylene glycol methyl methacrylate) was made from polyethylene glycol methyl methacrylate and azodiisobutyronitrile that have the same mass by full polymerization at 60° C., and then added into Comparative example 7.1 when a C═C double bond peak cannot be detected by infrared detection for the obtained polymer. Other conditions are consistent with Example 7.

### Comparative Example 7.2

A specific process of Comparative example 7.2 refers to Example 7. All other conditions are consistent with Example 7, except that polyethylene glycol methyl methacrylate monomer was not added in Comparative example 7.2.

### Example 8-12 and Other Comparative Examples

Specific processes of Examples 8-12 and other Comparative examples refer to Example 7. Main differences are the process condition of the positive electrode plate, the addition amount of each component, and the type of material for each component. Specific details are shown in Tables 5 and 6.

TABLE 5
Composition of positive electrode plates for Examples and Comparative examples

| | | Positive | | Polymer or | | Drying | |
|---|---|---|---|---|---|---|---|
| | | active | Conductive | monomer | | temperature | Drying |
| No. | Solvent/g | substance/g | agent/g | thereof/g | Binder/g | (° C.) | time (h) |
| Example 7 | 400 | 98.5 | 0.5 | 0.5 | 0.5 | 100 | 36 |
| Comparative | 400 | 98.5 | 0.5 | 0.5 | 0.5 | 100 | 36 |
| example 7.1 | | | | | | | |
| Comparative | 400 | 98.5 | 0.5 | — | 0.5 | 100 | 36 |
| example 7.2 | | | | | | | |
| Example 8 | 300 | 98 | 1 | 0.001 | 0.999 | 103 | 26 |
| Comparative | 300 | 98 | 1 | 0.001 | 0.999 | 103 | 26 |
| example 8.1 | | | | | | | |
| Comparative | 300 | 98 | 1 | — | 0.999 | 103 | 26 |
| example 8.2 | | | | | | | |
| Example 9 | 200 | 84 | 10 | 1 | 5 | 98 | 30 |
| Comparative | 200 | 84 | 10 | 1 | 5 | 98 | 30 |
| example 9.1 | | | | | | | |
| Comparative | 200 | 84 | 10 | — | 5 | 98 | 30 |
| example 9.2 | | | | | | | |
| Example 10 | 500 | 90.5 | 6 | 1.5 | 2 | 96 | 28 |
| Comparative | 500 | 90.5 | 6 | 1.5 | 2 | 96 | 28 |
| example 10.1 | | | | | | | |
| Comparative | 500 | 90.5 | 6 | — | 2 | 96 | 28 |
| example 10.2 | | | | | | | |
| Example 11 | 450 | 80 | 10 | 5 | 5 | 100 | 12 |
| Comparative | 450 | 80 | 10 | 5 | 5 | 100 | 12 |
| example 11.1 | | | | | | | |
| Comparative | 450 | 80 | 10 | — | 5 | 100 | 12 |
| example 11.2 | | | | | | | |
| Example 12 | 600 | 88 | 7.3 | 0.2 | 4.5 | 88 | 36 |
| Comparative | 600 | 88 | 7.3 | 0.2 | 4.5 | 88 | 36 |
| example 12.1 | | | | | | | |
| Comparative | 600 | 88 | 7.3 | — | 4.5 | 88 | 36 |
| example 12.2 | | | | | | | |

TABLE 6
Composition of positive electrode plates for Examples and Comparative examples

| | Positive | | | |
|---|---|---|---|---|
| | active | Conductive | | |
| No. | substance | agent | Polymer monomer/Polymer | Binder |
| Example 7 | Lithium | Conductive | Polyethylene glycol methyl methacrylate | Polyvinylidene |
| | cobaltate | carbon | (molecular weight of monomer 300) | fluoride |
| Comparative | | black | Poly (polyethylene glycol methyl methacrylate) | |
| example 7.1 | | | | |
| Comparative | | | — | |
| example 7.2 | | | | |
| Example 8 | Nickle | Conductive | Polyphenylene oxide acrylate (molecular | Polyvinylidene |
| | cobalt | carbon | weight of monomer 500) | fluoride |
| Comparative | manganese | black | Poly (polyphenylene oxide acrylate) | |
| example 8.1 | ternary | | | |
| Comparative | material | | — | |
| example 8.2 | | | | |
| Example 9 | Lithium | Conductive | Polycarbonate acrylate (molecular weight of | Polyvinylidene |
| | manganate + | fiber + | monomer 1500) | fluoride |
| Comparative | lithium- | Carbon | Poly (polycarbonate acrylate) | |
| example 9.1 | rich | nanotube | | |
| Comparative | manganese | (1:1) | — | |
| example 9.2 | based | | | |
| | material | | | |
| Example 10 | Ferrous | Carbon | Polyethylene glycol methyl methacrylate | Polyvinylidene |
| | lithium | nanotube + | (molecular weight of monomer 1000) | fluoride |
| Comparative | phosphate | graphene | Poly (polyethylene glycol methyl methacrylate) | |
| example 10.1 | | (1:2) | | |
| Comparative | | | — | |
| example 10.2 | | | | |
| Example 11 | Lithium- | Conductive | Polysiloxane methyl methacrylate (molecular | Polyvinylidene |
| | rich | carbon | weight of monomer 600) | fluoride - |
| Comparative | manganese | black | Poly (polysiloxane methyl methacrylate) | tetrafluoropropylene |
| example 11.1 | based | | | |
| Comparative | material | | — | |
| example 11.2 | | | | |
| Example 12 | Nickel | Carbon | Polyethylene glycol methyl dimethylacrylate | Polyvinylidene |
| | cobalt | nanotube + | (molecular weight of monomer 1000) | fluoride |
| Comparative | aluminum | graphene | Poly (polyethylene glycol methyl | |
| example 12.1 | material | (1:2) | dimethylacrylate) | |
| Comparative | | | — | |
| example 12.2 | | | | |

Where, the proportions in parentheses, unless otherwise specified, are all mass ratios. For example, the meaning of conductive carbon black + carbon nanotube (1:1) is that the mass ratio of conductive carbon black to carbon nanotube is (1:1).

Performance tests were conducted for the batteries prepared in the above Examples and Comparative examples.

(1) Alternating current impedance test method for battery internal resistance: Metrohm PGSTAT302N chemical workstation is used for alternating current impedance test on lithium ion battery of 50% SOC in a range of 100 KHz to 0.1 mHz at 25° C. The test results are listed in Table 7.

TABLE 7
Results of alternating current impedance tests for battery
internal resistance in Examples and Comparative examples

| | Battery | Battery | Battery | Battery |
|---|---|---|---|---|
| | internal | internal | internal | internal |
| | resistance | resistance | resistance | resistance |
| | after 100 | after 200 | after 300 | after 400 |
| No. | cycles (mΩ) | cycles (mΩ) | cycles (mΩ) | cycles (mΩ) |
| Example 7 | 13.61 | 20.47 | 27.52 | 34.53 |
| Comparative | 14.52 | 22.31 | 30.28 | 38.31 |
| example 7.1 | | | | |
| Comparative | 15.75 | 24.82 | 34.14 | 43.42 |
| example 7.2 | | | | |
| Example 8 | 6.41 | 8.83 | 11.26 | 13.74 |
| Comparative | 7.62 | 9.86 | 12.12 | 14.73 |
| example 8.1 | | | | |
| Comparative | 8.94 | 11.74 | 14.46 | 17.51 |
| example 8.2 | | | | |
| Example 9 | 21.11 | 31.75 | 44.05 | 55.71 |
| Comparative | 23.38 | 35.53 | 47.77 | 60.12 |
| example 9.1 | | | | |
| Comparative | 27.73 | 42.26 | 56.82 | 71.43 |
| example 9.2 | | | | |
| Example 10 | 8.41 | 13.42 | 18.51 | 23.73 |
| Comparative | 10.55 | 16.13 | 21.57 | 27.23 |
| example 10.1 | | | | |
| Comparative | 12.62 | 18.72 | 24.83 | 31.14 |
| example 10.2 | | | | |
| Example 11 | 31.43 | 46.46 | 61.58 | 76.81 |
| Comparative | 36.92 | 52.41 | 67.84 | 83.45 |
| example 11.1 | | | | |
| Comparative | 42.15 | 59.51 | 77.01 | 94.71 |
| example 11.2 | | | | |
| Example 12 | 5.14 | 10.84 | 16.62 | 22.51 |
| Comparative | 6.31 | 13.01 | 19.73 | 26.52 |
| example 12.1 | | | | |
| Comparative | 7.52 | 16.21 | 24.88 | 33.71 |
| example 12.2 | | | | |

The results of the internal resistance tests during cycling of battery indicate that the lithium ion batteries prepared in the Examples of the present disclosure have an internal resistance smaller than that of the lithium ion batteries prepared in the Comparative examples during cycling. The main reason is that the additive added in the disclosure can form a solid interfacial film on the surface of the positive electrode material. Such solid interfacial film is different from a solid interfacial film on a surface of a conventional positive electrode material; has functional characteristics of high content of polymer component and large molecular weight, etc.; has good interface stability; and can quickly conduct lithium ions, so that the prepared lithium ion battery has lower internal resistance. Meanwhile, the internal resistance of the lithium ion battery increases less during cycling, which has good application prospects.

(2) Test method for battery cycling performance: a charge and discharge cycling test for a lithium ion battery is conducted on a battery charge and discharge test cabinet (from LANHE), with the test conditions of 25° C., 0.5 C/0.5 C charge and discharge. The test results are listed in Table 8.

TABLE 8
Results of battery cycling performance tests
in Examples and Comparative examples

| | Battery | Battery | Battery | Battery |
|---|---|---|---|---|
| | capacity | capacity | capacity | capacity |
| | retention | retention | retention | retention |
| | ratio after | ratio after | ratio after | ratio after |
| | 100 cycles | 300 cycles | 500 cycles | 700 cycles |
| No. | (%) | (%) | (%) | (%) |
| Example 7 | 98.83 | 93.59 | 88.47 | 83.41 |
| Comparative | 97.61 | 92.47 | 87.41 | 82.32 |
| example 7.1 | | | | |
| Comparative | 96.44 | 90.63 | 85.13 | 79.32 |
| example 7.2 | | | | |
| Example 8 | 99.63 | 95.20 | 90.91 | 86.64 |
| Comparative | 98.46 | 93.65 | 89.12 | 84.31 |
| example 8.1 | | | | |
| Comparative | 97.48 | 91.53 | 85.91 | 80.24 |
| example 8.2 | | | | |
| Example 9 | 97.16 | 88.75 | 80.76 | 72.54 |
| Comparative | 95.68 | 86.61 | 77.61 | 68.73 |
| example 9.1 | | | | |
| Comparative | 93.21 | 82.44 | 71.62 | 61.13 |
| example 9.2 | | | | |
| Example 10 | 98.92 | 96.56 | 94.27 | 92.13 |
| Comparative | 97.75 | 95.43 | 93.15 | 90.73 |
| example 10.1 | | | | |
| Comparative | 96.84 | 93.61 | 90.56 | 87.71 |
| example 10.2 | | | | |
| Example 11 | 96.59 | 87.23 | 78.18 | 68.83 |
| Comparative | 94.61 | 82.89 | 71.45 | 59.72 |
| example 11.1 | | | | |
| Comparative | 91.13 | 74.51 | 58.63 | 42.53 |
| example 11.2 | | | | |
| Example 12 | 98.95 | 96.04 | 93.18 | 90.53 |
| Comparative | 97.36 | 94.13 | 91.10 | 87.82 |
| example 12.1 | | | | |
| Comparative | 95.15 | 90.63 | 86.31 | 81.81 |
| example 12.2 | | | | |

The cycling performance test results of the Examples and the Comparative examples show: the capacity retention rate of the lithium ion batteries prepared in the Examples of the present disclosure is higher than that of the lithium ion batteries prepared in the Comparative examples during cycling. The main reason is that the additive added in the disclosure can form a solid interfacial film on the surface of the positive electrode material. Such solid interfacial film is different from a solid interfacial film on the surface of the conventional positive electrode material, has characteristics of high content of polymer component, large molecular weight, high-speed lithium ion conduction, good stability, and the like. During the battery cycling, for the solid interfacial film on the surface of the conventional positive electrode material, along with the charge and discharge of lithium-ion battery, unstable components in the solid interfacial film on the surface of positive material will dissolve, thus generating more new interfaces at the interface of positive electrode. The new interfaces consume the electrolyte and lithium salt, and further form a solid interfacial film, which will reduce the battery performance. In the disclosure, due to the addition of the additive, a solid interfacial film with higher molecular weight, more stable molecular structure, and higher lithium ion conductivity, can be formed on the surface of the positive electrode material, which can greatly improve the battery cycling performance.

The cycling charge and discharge test results of the Examples and the Comparative examples show: the positive electrode plate prepared by the present disclosure has low internal resistance during cycling, and there are good lithium ion and electron conducting channels inside the positive electrode plate, which makes the prepared lithium ion battery have good cycling performance.

### Example 13

1) Preparation of Positive Electrode Plate

98.5 g of lithium cobaltate as a positive active substance, 2 g of polyvinylidene fluoride (PVDF) as a binder, 2 g of carbon black as a conductive agent, 1 g of carbon nanotube as a conductive agent were mixed, 400 g of N-methylpyrrolidone (NMP) was added and stirred under the action of a vacuum mixer until the mixed system became a positive electrode slurry with uniform fluidity; the positive electrode slurry was coated evenly on an aluminum foil with a thickness of 12 μm; after drying at 100° C. for 36 hours, the coated aluminum foil was vacuumized to obtain an electrode plate; and the electrode plate was rolled, and then cut to obtain the positive electrode plate.

2) Preparation of Negative Electrode Plate

27 g of SiO, 50 g of graphite, 5 g of single-walled carbon nanotube (SWCNT) as a conductive agent, 10 g of conductive carbon black (SP) as a conductive agent, 4 g of sodium carboxymethyl cellulose (CMC) as a binder, 4 g of styrene butadiene rubber (SBR) as a binder, and 500 g of deionized water were prepared into a slurry using a wet process. The slurry was coated on a surfaces of a copper foil for a negative current collector, and then the coated copper foil was dried, rolled and die-cut, to obtain the negative electrode plate.

3) Preparation of Electrolyte

In a glove box filled with argon gas where water and oxygen contents were qualified, ethylene carbonate, propylene carbonate, diethyl carbonate and n-propyl propionate were mixed in a proportion of 20:10:15:55 by mass ratio to be uniform, then 1 mol/L of fully dried lithium hexafluorophosphate (LiPF₆) was quickly added into the mixture, and stirred evenly, to obtain the electrolyte.

4) Preparation of Separator

20 g of aluminum oxide, 25 g of polyvinylidene fluoride-hexafluoropropylene, 0.1 g of polyethylene glycol methyl methacrylate, and 200 g of acetone were mixed uniformly, then coated on surfaces of both sides of a polyethylene separator substrate with a thickness of 6 mm, and dried, to obtain the separator.

5) Preparation of Lithium Ion Battery

The positive electrode plate, the negative electrode plate, and the separator obtained above were used to prepare a cell of lithium ion battery, which was injected with the electrolyte, encapsulated and welded, to obtain the lithium ion battery.

### Comparative Example 13.1

A specific process of Comparative example 13.1 refers to Example 13, and the main difference between them is that in Comparative example 13.1, poly(polyethylene glycol methyl methacrylate) was used in the same mass as polyethylene glycol methyl methacrylate monomer of Example 13, where the poly(polyethylene glycol methyl methacrylate) was made from polyethylene glycol methyl methacrylate and azodiisobutyronitrile that have the same mass by full polymerization at 60° C., and then added into Comparative example 13.1 when a C═C double bond peak cannot be detected by infrared detection for the obtained polymer. Other conditions are consistent with Example 13.

### Comparative Example 13.2

A specific process of Comparative example 13.2 refers to Example 13. All other conditions are consistent with Example 13, except that polyethylene glycol methyl methacrylate monomer was not added in Comparative example 13.2.

### Examples 14-18 and Other Comparative Examples

Specific processes of Examples 14-18 and other Comparative examples refer to Example 13. Main differences are the amount of components added to the separator and the type of material for each component. Specific details are shown in Tables 9 and 10.

TABLE 9
Composition of separators for Examples and Comparative examples

| | | | | | | Single-sided | | |
|---|---|---|---|---|---|---|---|---|
| | | | | Polymer or | Thickness of | thickness of | Drying | |
| | | | | monomer | separator | separator | temperature | Drying |
| No. | Solvent/g | Ceramic/g | Binder/g | thereof/g | substrate/μm | coating/μm | (° C.) | time (h) |
| Example 13 | 200 | 20 | 25 | 0.1 | 6 | 1.5 | 60 | 12 |
| Comparative | 200 | 20 | 25 | 0.1 | 6 | 1.5 | 60 | 12 |
| example 13.1 | | | | | | | | |
| Comparative | 200 | 20 | 25 | — | 6 | 1.5 | 60 | 12 |
| example 13.2 | | | | | | | | |
| Example 14 | 100 | 50 | 40 | 10 | 8 | 0.5 | 85 | 10 |
| Comparative | 100 | 50 | 40 | 10 | 8 | 0.5 | 85 | 10 |
| example 14.1 | | | | | | | | |
| Comparative | 100 | 50 | 40 | — | 8 | 0.5 | 85 | 10 |
| example 14.2 | | | | | | | | |
| Example 15 | 400 | 20 | 29 | 1 | 7 | 2.5 | 90 | 16 |
| Comparative | 400 | 20 | 29 | 1 | 7 | 2.5 | 90 | 16 |
| example 15.1 | | | | | | | | |
| Comparative | 400 | 20 | 29 | — | 7 | 2.5 | 90 | 16 |
| example 15.2 | | | | | | | | |
| Example 16 | 230 | 9.5 | 90 | 0.5 | 10 | 5 | 75 | 20 |
| Comparative | 230 | 9.5 | 90 | 0.5 | 10 | 5 | 75 | 20 |
| example 16.1 | | | | | | | | |
| Comparative | 230 | 9.5 | 90 | — | 10 | 5 | 75 | 20 |
| example 16.2 | | | | | | | | |
| Example 17 | 500 | 23 | 75 | 2 | 5 | 1 | 65 | 15 |
| Comparative | 500 | 23 | 75 | 2 | 5 | 1 | 65 | 15 |
| example 17.1 | | | | | | | | |
| Comparative | 500 | 23 | 75 | — | 5 | 1 | 65 | 15 |
| example 17.2 | | | | | | | | |
| Example 18 | 360 | 30 | 65 | 5 | 12 | 3 | 80 | 18 |
| Comparative | 360 | 30 | 65 | 5 | 12 | 3 | 80 | 18 |
| example 18.1 | | | | | | | | |
| Comparative | 360 | 30 | 65 | — | 12 | 3 | 80 | 18 |
| example 18.2 | | | | | | | | |

TABLE 10
Composition of separators for Examples and Comparative examples

| | | | | Separator |
|---|---|---|---|---|
| No. | Ceramic | Binder | Polymer monomer/Polymer | substrate |
| Example 13 | Aluminum | Polytetrafluoropropene - | Polyethylene glycol methyl | Polyethylene |
| | oxide | hexafluoropropylene | methacrylate (molecular weight of | |
| | | | monomer 300) | |
| Comparative | | | Poly (polyethylene glycol methyl | |
| example 13.1 | | | methacrylate) | |
| Comparative | | | — | |
| example 13.2 | | | | |
| Example 14 | Boehmite | Polyhexafluoroethylene | Polyphenylene oxide acrylate | Polypropylene |
| | | metafluoro-propylene | (molecular weight of monomer 500) | |
| Comparative | | | Poly (polyphenylene oxide acrylate) | |
| example 14.1 | | | | |
| Comparative | | | — | |
| example 14.2 | | | | |
| Example 15 | Silicon | Polyvinylidene fluoride | Polycarbonate acrylate (molecular | Polyethylene |
| | dioxide | | weight of monomer 1500) | |
| Comparative | | | Poly (polycarbonate acrylate) | |
| example 15.1 | | | | |
| Comparative | | | — | |
| example 15.2 | | | | |
| Example 16 | Aluminum | Polytetrafluoroethylene | Polyethylene glycol methyl | Polypropylene |
| | oxide + | | methacrylate (molecular weight of | |
| | boehmite | | monomer 1000) | |
| Comparative | (1:1) | | Poly (polyethylene glycol methyl | |
| example 16.1 | | | methacrylate) | |
| Comparative | | | — | |
| example 16.2 | | | | |
| Example 17 | Aluminum | Polyhexafluoroethylene | Polysiloxane methyl methacrylate | Polyethylene |
| | oxide + | | (molecular weight of monomer 600) | |
| Comparative | silicon | metafluoro-propylene | Poly (polysiloxane methyl | |
| example 17.1 | dioxide | | methacrylate) | |
| Comparative | (1:2) | | — | |
| example 17.2 | | | | |
| Example 18 | Silicon | Polyvinylidene fluoride | Polyethylene glycol methyl | Polyethylene |
| | dioxide + | | dimethylacrylate (molecular weight | |
| | boehmite | | of monomer 1000) | |
| Comparative | (1:5) | | Poly (polyethylene glycol methyl | |
| example 18.1 | | | dimethylacrylate) | |
| Comparative | | | — | |
| example 18.2 | | | | |

Where, the proportions in parentheses, unless otherwise specified, are all mass ratios. For example, the meaning of aluminum oxide + boehmite (1:1) is that the mass ratio of aluminum oxide to boehmite is (1:1).

Performance tests were conducted for the batteries prepared in the above Examples and Comparative examples.

(1) Alternating current impedance test method for battery internal resistance: Metrohm PGSTAT302N chemical workstation is used for alternating current impedance test on lithium ion battery of 50% SOC in a range of 100 KHz to 0.1 mHz at 25° C. The test results are listed in Table 11.

TABLE 11
Results of alternating current impedance tests for battery
internal resistance in Examples and Comparative examples

| | Battery | Battery | Battery | Battery |
|---|---|---|---|---|
| | internal | internal | internal | internal |
| | resistance | resistance | resistance | resistance |
| | after 100 | after 200 | after 300 | after 400 |
| No. | cycles (mΩ) | cycles (mΩ) | cycles (mΩ) | cycles (mΩ) |
| Example 13 | 23.45 | 34.61 | 45.51 | 56.49 |
| Comparative | 26.25 | 38.11 | 49.74 | 61.52 |
| example 13.1 | | | | |
| Comparative | 30.16 | 43.32 | 56.51 | 69.91 |
| example 13.2 | | | | |
| Example 14 | 21.61 | 32.02 | 42.55 | 53.38 |
| Comparative | 25.31 | 36.13 | 47.03 | 57.85 |
| example 14.1 | | | | |
| Comparative | 30.21 | 41.51 | 52.73 | 64.14 |
| example 14.2 | | | | |
| Example 15 | 14.22 | 21.72 | 29.61 | 37.33 |
| Comparative | 17.51 | 26.15 | 34.43 | 43.12 |
| example 15.1 | | | | |
| Comparative | 21.32 | 31.12 | 40.63 | 50.43 |
| example 15.2 | | | | |
| Example 16 | 32.61 | 42.75 | 53.17 | 63.21 |
| Comparative | 36.55 | 48.23 | 59.86 | 71.48 |
| example 16.1 | | | | |
| Comparative | 41.21 | 55.45 | 69.91 | 84.14 |
| example 16.2 | | | | |
| Example 17 | 12.42 | 18.91 | 26.25 | 31.61 |
| Comparative | 15.54 | 22.94 | 30.53 | 37.72 |
| example 17.1 | | | | |
| Comparative | 19.15 | 27.59 | 35.84 | 44.17 |
| example 17.2 | | | | |
| Example 18 | 45.93 | 59.58 | 73.12 | 86.57 |
| Comparative | 49.42 | 64.73 | 80.16 | 95.31 |
| example 18.1 | | | | |
| Comparative | 54.11 | 73.69 | 93.35 | 112.82 |
| example 18.2 | | | | |

The results of the internal resistance tests during cycling of battery show that: the lithium ion batteries prepared in the Examples of the present disclosure have an internal resistance smaller than that of the lithium ion batteries prepared in the Comparative examples during cycling. The main reason is that the additive added in the separator of the present disclosure can form interfacial films on the surfaces of the positive and negative electrode materials. These interfacial films are different from interfacial films on surfaces of conventional positive and negative electrode materials; have functional characteristics of high content of polymer component, good stability, large molecular weight, and high-speed lithium ion conduction, and the like; and can quickly conduct lithium ions, thus leading to a belier interfacial stability. The internal resistance of the lithium ion battery increases less during cycling, which has good application prospects.

(2) Test method for battery cycling performance: a charge and discharge cycling test for a lithium ion battery is conducted on a battery charge and discharge test cabinet (from LANHE), with the test conditions of 25° C., 0.5 C/0.5 C charge and discharge. The test results are listed in Table 12.

TABLE 12
Results of battery cycling performance tests
in Examples and Comparative examples

| | Battery | Battery | Battery | Battery |
|---|---|---|---|---|
| | capacity | capacity | capacity | capacity |
| | retention | retention | retention | retention |
| | ratio after | ratio after | ratio after | ratio after |
| | 100 cycles | 300 cycles | 500 cycles | 700 cycles |
| No. | (%) | (%) | (%) | (%) |
| Example 13 | 97.12 | 92.86 | 88.52 | 84.74 |
| Comparative | 96.53 | 91.67 | 86.71 | 81.51 |
| example 13.1 | | | | |
| Comparative | 95.67 | 90.45 | 85.32 | 80.12 |
| example 13.2 | | | | |
| Example 14 | 98.81 | 94.83 | 90.91 | 87.01 |
| Comparative | 97.52 | 92.43 | 87.47 | 82.34 |
| example 14.1 | | | | |
| Comparative | 96.13 | 91.14 | 86.21 | 81.24 |
| example 14.2 | | | | |
| Example 15 | 98.35 | 94.42 | 90.58 | 86.54 |
| Comparative | 97.74 | 93.13 | 88.35 | 83.61 |
| example 15.1 | | | | |
| Comparative | 96.13 | 91.13 | 86.27 | 81.25 |
| example 15.2 | | | | |
| Example 16 | 97.72 | 93.13 | 88.47 | 83.83 |
| Comparative | 96.41 | 91.54 | 86.61 | 81.72 |
| example 16.1 | | | | |
| Comparative | 95.73 | 90.64 | 85.61 | 80.41 |
| example 16.2 | | | | |
| Example 17 | 98.73 | 94.47 | 90.15 | 85.87 |
| Comparative | 97.61 | 92.96 | 88.32 | 83.61 |
| example 17.1 | | | | |
| Comparative | 96.26 | 91.67 | 87.16 | 82.47 |
| example 17.2 | | | | |
| Example 18 | 98.04 | 92.26 | 86.45 | 80.63 |
| Comparative | 96.91 | 90.73 | 84.53 | 78.31 |
| example 18.1 | | | | |
| Comparative | 95.61 | 89.33 | 83.24 | 76.92 |
| example 18.2 | | | | |

The cycling performance test results of the Examples and the Comparative examples show: the capacity retention rate of the lithium ion batteries prepared in the Examples of the present disclosure is higher than that of the lithium ion batteries prepared in the Comparative examples during cycling. The main reason is that the additive added in the separator of the present disclosure can form interfacial films on the surfaces of the positive and negative electrode materials. These interfacial films on the positive and negative electrodes are different from solid interfacial films on surfaces of conventional positive and negative electrode materials; have characteristics of high content of polymer component, good stability, large molecular weight, high-speed lithium ion conduction, and the like. The interfacial films on the surfaces of the conventional positive and negative electrode materials are formed during charge and discharge of the battery, and the surfaces of the positive and negative electrode materials, along with the charge and discharge the lithium-ion battery, show irregular volume expansion, producing more interfacial films. There are some unstable structures in the interfacial film, which will be dissolved in the electrolyte during the battery cycling. With the dissolution and continuous generation of unstable components in the interfacial film, the battery performance will be reduced. By introducing the additive into the separator of the present disclosure, a more stable interfacial film with higher lithium ion conduction performance can be formed on the surface of the positive and negative electrode materials, which can greatly improve the stability and lithium ion conduction performance of the interfacial film.

The cycling charge and discharge test results of the Examples and the Comparative examples show: the secondary battery prepared with the separator of the present disclosure has low internal resistance during cycling, making the prepared lithium ion battery have good cycling performance.

### Example 19

1) Preparation of Positive Electrode Plate

97 g of lithium cobaltate as a positive active substance, 1 g of polyvinylidene fluoride (PVDF) as a binder, 1 g of carbon black as a conductive agent, 1 g of carbon nanotube as a conductive agent were mixed, 400 g of N-methylpyrrolidone (NMP) was added and stirred under the action of a vacuum mixer until the mixed system became a positive electrode slurry with uniform fluidity; the positive electrode slurry was coated evenly on an aluminum foil with a thickness of 12 μm; after drying at 100° C. for 36 hours, the coated aluminum foil was vacuumized to obtain an electrode plate; and the electrode plate was rolled, and then cut to obtain the positive electrode plate.

2) Preparation of Negative Electrode Plate

27 g of SiO, 50 g of graphite, 5 g of single-walled carbon nanotube (SWCNT) as a conductive agent, 10 g of conductive carbon black (SP) as a conductive agent, 4 g of sodium carboxymethyl cellulose (CMC) as a binder, 4 g of styrene butadiene rubber (SBR) as a binder, and 500 g of deionized water were prepared into a slurry using a wet process. The slurry was coated on a surface of a copper foil for a negative current collector, and then the coated copper foil was dried, rolled and die-cut, to obtain the negative electrode plate.

3) Preparation of Electrolyte

In a glove box filled with argon gas where water and oxygen contents were qualified, 20 g of ethylene carbonate, 10 g of propylene carbonate, 15 g of diethyl carbonate and 55 g of n-propyl propionate were uniformly mixed at a proportion to be uniform, 0.1 g of fully dried polyethylene glycol methyl methacrylate monomer was added and stirred evenly, then 1 mol/L of fully dried lithium hexafluorophosphate (LiPF₆) was quickly added into the mixture, and stirred evenly, to obtain the electrolyte.

4) Preparation of Separator

30 g of aluminum oxide, 20 g of polyvinylidene fluoride-hexafluoropropylene, and 200 g of acetone were mixed uniformly, then coated on a surface of a polyethylene separator substrate, and dried, to obtain the separator.

5) Preparation of Lithium Ion Battery

The positive electrode plate, the negative electrode plate, and the separator obtained above were used to prepare a cell of lithium ion battery, which was injected with the electrolyte, encapsulated and welded, to obtain the lithium ion battery.

### Comparative Example 19.1

A specific process of Comparative example 19.1 refers to Example 19, and the main difference between them is that in Comparative example 19.1, poly(polyethylene glycol methyl methacrylate) was used in the same mass as polyethylene glycol methyl methacrylate monomer of Example 19, where the poly(polyethylene glycol methyl methacrylate) was made from polyethylene glycol methyl methacrylate and azodiisobutyronitrile that have the same mass by full polymerization at 60° C., and then added into Comparative example 19.1 when a C═C double bond peak cannot be detected by infrared detection for the obtained polymer. Other conditions are consistent with Example 19.

### Comparative Example 19.2

A specific process of Comparative example 19.2 refers to Example 19. All other conditions are consistent with Example 19, except that polyethylene glycol methyl methacrylate monomer was not added in Comparative example 19.2.

### Examples 20-24 and Other Comparative Examples

Specific processes of Examples 20-24 and other Comparative examples refer to Example 19. Main differences are the process conditions of the negative electrode plate, the addition amount of each component, and the type of material for each component. Specific details are shown in Tables 13 and 14.

TABLE 13
Composition of electrolytes for Examples and Comparative examples

| | | | | | Polymer or | Lithium salt |
|---|---|---|---|---|---|---|
| | Ethylene | Propylene | Diethyl | N-propyl | monomer | concentration/ |
| No. | carbonate/g | carbonate/g | carbonate/g | propionate/g | thereof/g | (mol/L) |
| Example 19 | 20 | 10 | 15 | 55 | 0.1 | 1.00 |
| Comparative | 20 | 10 | 15 | 55 | 0.1 | 1.00 |
| example 19.1 | | | | | | |
| Comparative | 20 | 10 | 15 | 55 | — | 1.00 |
| example 19.2 | | | | | | |
| Example 20 | 14 | 15 | 35 | 25 | 1 | 1.05 |
| Comparative | 14 | 15 | 35 | 25 | 1 | 1.05 |
| example 20.1 | | | | | | |
| Comparative | 14 | 15 | 35 | 25 | — | 1.05 |
| example 20.2 | | | | | | |
| Example 21 | 5 | 5 | 50 | 40 | 0.01 | 1.08 |
| Comparative | 5 | 5 | 50 | 40 | 0.01 | 1.08 |
| example 21.1 | | | | | | |
| Comparative | 5 | 5 | 50 | 40 | — | 1.08 |
| example 21.2 | | | | | | |
| Example 22 | 25 | 19 | 21 | 30 | 5 | 1.10 |
| Comparative | 25 | 19 | 21 | 30 | 5 | 1.10 |
| example 22.1 | | | | | | |
| Comparative | 25 | 19 | 21 | 30 | — | 1.10 |
| example 22.2 | | | | | | |
| Example 23 | 20 | 15 | 25 | 40 | 0.2 | 1.05 |
| Comparative | 20 | 15 | 25 | 40 | 0.2 | 1.05 |
| example 23.1 | | | | | | |
| Comparative | 20 | 15 | 25 | 40 | — | 1.05 |
| example 23.2 | | | | | | |
| Example 24 | 20 | 27 | 20 | 30 | 3 | 1.15 |
| Comparative | 20 | 27 | 20 | 30 | 3 | 1.15 |
| example 24.1 | | | | | | |
| Comparative | 20 | 27 | 20 | 30 | — | 1.15 |
| example 24.2 | | | | | | |

TABLE 14
Composition of electrolytes for
Examples and Comparative examples

| No. | Polymer monomer/Polymer |
|---|---|
| Example 19 | Polyethylene glycol methyl methacrylate |
| | (molecular weight of monomer 300) |
| Comparative | Poly (polyethylene glycol methyl methacrylate) |
| example 19.1 | |
| Comparative | — |
| example 19.2 | |
| Example 20 | Polyphenylene oxide acrylate (molecular weight |
| | of monomer 500) |
| Comparative | Poly (polyphenylene oxide acrylate) |
| example 20.1 | |
| Comparative | — |
| example 20.2 | |
| Example 21 | Polycarbonate acrylate (molecular weight of |
| | monomer 1500) |
| Comparative | Poly (polycarbonate acrylate) |
| example 21.1 | |
| Comparative | — |
| example 21.2 | |
| Example 22 | Polyethylene glycol methyl methacrylate |
| | (molecular weight of monomer 1000) |
| Comparative | Poly (polyethylene glycol methyl methacrylate) |
| example 22.1 | |
| Comparative | — |
| example 22.2 | |
| Example 23 | Polysiloxane methyl methacrylate (molecular |
| | weight of monomer 600) |
| Comparative | Poly (polysiloxane methyl methacrylate) |
| example 23.1 | |
| Comparative | — |
| example 23.2 | |
| Example 24 | Polyethylene glycol methyl dimethylacrylate |
| | (molecular weight of monomer 1000) |
| Comparative | Poly (polyethylene glycol methyl dimethylacrylate) |
| example 24.1 | |
| Comparative | — |
| example 24.2 | |

Performance tests were conducted for the batteries prepared in the above examples and comparative examples:

(1) Alternating current impedance test method for battery internal resistance: Metrohm PGSTAT302N chemical workstation is used for alternating current impedance test on lithium ion battery of 50% SOC in a range of 100 K4 Hz to 0.1 mHz at 25° C. The test results are listed in Table 15.

TABLE 15
Results of alternating current impedance tests for battery
internal resistance in Examples and Comparative examples

| | Battery | Battery | Battery | Battery |
|---|---|---|---|---|
| | internal | internal | internal | internal |
| | resistance | resistance | resistance | resistance |
| | after 100 | after 200 | after 300 | after 400 |
| No. | cycles (mΩ) | cycles (mΩ) | cycles (mΩ) | cycles (mΩ) |
| Example 19 | 23.63 | 30.57 | 37.59 | 44.87 |
| Comparative | 25.82 | 33.52 | 41.59 | 49.41 |
| example 19.1 | | | | |
| Comparative | 27.16 | 35.71 | 44.17 | 52.52 |
| example 19.2 | | | | |
| Example 20 | 17.32 | 23.54 | 29.79 | 36.18 |
| Comparative | 18.96 | 25.98 | 32.94 | 39.87 |
| example 20.1 | | | | |
| Comparative | 20.17 | 27.13 | 33.98 | 40.74 |
| example 20.2 | | | | |
| Example 21 | 24.71 | 29.02 | 33.35 | 37.71 |
| Comparative | 26.13 | 31.49 | 36.86 | 42.13 |
| example 21.1 | | | | |
| Comparative | 27.52 | 33.52 | 39.39 | 45.31 |
| example 21.2 | | | | |
| Example 22 | 32.53 | 37.45 | 42.31 | 47.23 |
| Comparative | 33.95 | 39.29 | 44.58 | 49.87 |
| example 22.1 | | | | |
| Comparative | 35.81 | 41.15 | 46.36 | 51.54 |
| example 22.2 | | | | |
| Example 23 | 20.63 | 26.81 | 32.94 | 39.14 |
| Comparative | 22.45 | 29.05 | 35.65 | 42.22 |
| example 23.1 | | | | |
| Comparative | 25.02 | 31.59 | 38.13 | 44.71 |
| example 23.2 | | | | |
| Example 24 | 21.27 | 28.19 | 35.45 | 42.57 |
| Comparative | 23.83 | 31.21 | 38.60 | 45.81 |
| example 24.1 | | | | |
| Comparative | 25.45 | 32.85 | 40.43 | 47.97 |
| example 24.2 | | | | |

The results of the internal resistance tests during the battery cycling show that: the lithium ion batteries prepared in the Examples of the present disclosure have an internal resistance smaller than that of the lithium ion batteries prepared in the Comparative examples during cycling. The main reason is that the additive added in the disclosure can form interfacial films on the surfaces of the positive and negative electrode materials. These interfacial films are different from interfacial films on surfaces of conventional positive and negative electrode materials; has functional characteristics of high content of polymer component, large molecular weight, and high-speed lithium ion conduction, and the like; and can quickly conduct lithium ions, so that the prepared lithium ion battery has lower internal resistance. Meanwhile, the internal resistance of the lithium ion battery increases less during cycling, which has good application prospects.

(2) Test method for battery cycling performance: a charge and discharge cycling test for a lithium ion battery is conducted on a battery charge and discharge test cabinet (from LANHE), with the test conditions of 25° C., 0.5 C/0.5 C charge and discharge. The test results are listed in Table 16.

TABLE 16
Test results of battery cycling performance
in Examples and Comparative examples

| | Battery | Battery | Battery | Battery |
|---|---|---|---|---|
| | capacity | capacity | capacity | capacity |
| | retention | retention | retention | retention |
| | ratio after | ratio after | ratio after | ratio after |
| | 100 cycles | 300 cycles | 500 cycles | 700 cycles |
| No. | (%) | (%) | (%) | (%) |
| Example 19 | 98.22 | 94.03 | 89.93 | 85.68 |
| Comparative | 97.73 | 92.95 | 88.16 | 83.46 |
| example 19.1 | | | | |
| Comparative | 96.64 | 91.83 | 87.04 | 82.33 |
| example 19.2 | | | | |
| Example 20 | 98.67 | 95.42 | 92.13 | 88.74 |
| Comparative | 97.43 | 93.32 | 89.21 | 85.13 |
| example 20.1 | | | | |
| Comparative | 96.68 | 91.91 | 87.18 | 82.53 |
| example 20.2 | | | | |
| Example 21 | 97.77 | 92.18 | 86.45 | 80.71 |
| Comparative | 96.58 | 90.21 | 83.80 | 77.43 |
| example 21.1 | | | | |
| Comparative | 95.41 | 88.68 | 82.01 | 75.35 |
| example 21.2 | | | | |
| Example 22 | 98.81 | 95.76 | 92.72 | 89.53 |
| Comparative | 97.75 | 93.93 | 90.05 | 86.21 |
| example 22.1 | | | | |
| Comparative | 96.82 | 92.83 | 88.92 | 85.04 |
| example 22.2 | | | | |
| Example 23 | 98.42 | 94.57 | 90.62 | 86.68 |
| Comparative | 97.16 | 93.01 | 88.91 | 84.81 |
| example 23.1 | | | | |
| Comparative | 96.68 | 92.23 | 87.63 | 83.26 |
| example 23.2 | | | | |
| Example 24 | 98.12 | 94.27 | 90.48 | 86.51 |
| Comparative | 97.21 | 92.83 | 88.60 | 84.31 |
| example 24.1 | | | | |
| Comparative | 96.65 | 92.34 | 87.91 | 83.62 |
| example 24.2 | | | | |

The cycling performance test results of the Examples and the Comparative examples show: the capacity retention rate of the lithium ion batteries prepared in the Examples of the present disclosure is higher than that of the lithium ion batteries prepared in the Comparative examples during cycling. The main reason is that the additive added in the disclosure can form interfacial films on the surfaces of the positive and negative electrode materials. These interfacial films are different from interfacial films on surfaces of conventional positive and negative electrode materials; have characteristics of high content of polymer content, good stability, high-speed lithium ion conduction, and the like. The interfacial films on the surfaces of conventional positive and negative electrode materials are formed during first charge and discharge of the lithium ion battery. With the charge and discharge of the lithium ion battery, the interfacial film will be partially dissolved and continuously generated. The newly generated interfacial film components need to consume electrolyte and lithium salt, which will reduce the performance of the lithium ion battery. In the disclosure, due to the addition of the additive, a more stable interfacial film can be formed on the surfaces of positive and negative electrode materials, which can improve the performance of the battery.

The cycling charge and discharge test results of the Examples and the Comparative examples show: the lithium ion battery prepared with the electrolyte of the present disclosure has low internal resistance during cycling, and the lithium ion battery has good cycling performance.

The embodiments of the present disclosure have been described above. However, the present disclosure is not limited to the above embodiments. Any modification, equivalent replacement, improvement, and the like made within the spirit and principle of the present disclosure shall be included in the protection scope of the present disclosure.

What is claimed is:

1. A secondary battery, wherein the secondary battery comprises an additive, and the additive is selected from at least one of compounds represented by Formula 1:
R₁—R-M-R′—R′₁ Formula 1
where, M is selected from polyphenylene oxide segment, polyethylene glycol segment, polyethylene dithiol segment, polycarbonate segment, polypropylene glycol segment or polysiloxane segment; R₁ and R′₁ are capping groups, and at least one of R₁ and R′₁ comprises a carbon-carbon double bond or a carbon-carbon triple bond as end group; R and R′ are linking groups.

2. The secondary battery according to claim 1, wherein R₁ and R′₁ are capping groups, and at least one of R₁ and R′₁ comprises at least one of following groups as an end group: —O—(C═O)—C(R₂)═C(R′₂)(R′₂), —N(R₃)—(C═O)—C(R₂)═C(R′₂)(R′₂), —C(R₂)═C(R′₂)(R′₂), and —C≡C—R′₂; wherein R₂ is selected from H or organic functional groups; R′₂ is the same or different and is independently selected from H or organic functional groups; R₃ is selected from H or C₁₋₃ alkyl group.

3. The secondary battery according to claim 1, wherein R and R′ are the same or different, and are independently selected from alkylene, and —NR₃—, if present, wherein R₃ is H or C₁₋₃ alkyl.

4. The secondary battery according to claim 1, wherein the polyphenylene oxide segment has a repeating unit represented by Formula 2: 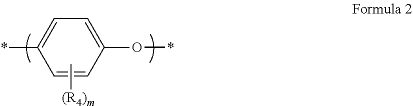
wherein R₄ is selected from H or C₁₋₆ alkyl group, and m is an integer between 0 and 4; and/or,
the polyethylene glycol segment has a repeating unit represented by Formula 3: 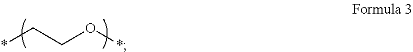
and/or,
the polypropylene glycol segment has a repeating unit represented by Formula 4: 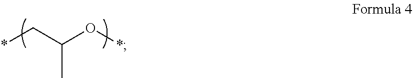
and/or,
the polyethylene dithiol segment has a repeating unit represented by Formula 5: 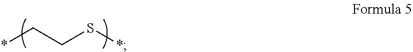
and/or,
the polycarbonate segment has a repeating unit represented by Formula 6: 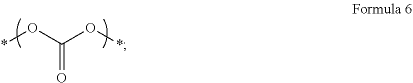
and/or,
the polysiloxane segment has a repeating unit represented by Formula 7:

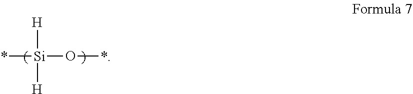

5. The secondary battery according to claim 1, wherein the compound represented by Formula 1 is selected from at least one of polyethylene dithiol acrylate, polyethylene dithiol methacrylate, polyethylene dithiol diacrylate, polyethylene dithiol dimethacrylate, polyethylene dithiol phenyl ether acrylate, polyethylene dithiol mono allyl ether, polyethylene glycol acrylate, polyethylene glycol methacrylate, polyethylene glycol diacrylate, polyethylene glycol dimethacrylate, polyethylene glycol phenyl ether acrylate, polyethylene glycol mono allyl ether, polycarbonate acrylate, polycarbonate methacrylate, polycarbonate diacrylate, polycarbonate dimethacrylate, polycarbonate phenyl ether acrylate, polycarbonate mono allyl ether, polypropylene glycol acrylate, polypropylene glycol methacrylate, polypropylene glycol diacrylate, polypropylene glycol dimethacrylate, polypropylene glycol phenyl ether acrylate, polypropylene glycol mono allyl ether, polysiloxane acrylate, polysiloxane methacrylate, polysiloxane diacrylate, polysiloxane dimethacrylate, polysiloxane phenyl ether acrylate, and polysiloxane mono allyl ether.

6. The secondary battery according to claim 1, wherein the secondary battery comprises a positive electrode plate, a negative electrode plate, a separator, and an electrolyte; and at least one of the positive electrode plate, the separator, and the electrolyte contains the additive.

7. The secondary battery according to claim 1, wherein the secondary battery comprises a positive electrode plate, wherein the positive electrode plate comprises a positive current collector and a positive active substance layer coated on one-side or both-side surfaces of the positive current collector, and the positive active substance layer comprises a positive active substance, a conductive agent, a binder, and the additive;
the positive active substance layer comprises components with the following mass percentage content: 80-98.5 wt % of positive active substance, 0.5-10 wt % of the conductive agent, 0.5-5 wt % of the binder, and 0.001-5 wt % of the additive.

8. The secondary battery according to claim 1, wherein the secondary battery comprises a separator, wherein the separator comprises a separator substrate and a composite layer coated on one-side or both-side surfaces of the separator substrate, and the composite layer comprises a binder and the additive;
the composite layer comprises components with the following mass percentage content: 0-50 wt % of the ceramic, 40-90 wt % of the binder, and 0.1-10 wt % of the additive.

9. The secondary battery according to claim 8, wherein the composite layer further comprises a ceramic.

10. The secondary battery according to claim 1, wherein the secondary battery comprises an electrolyte, and the electrolyte comprises a non-aqueous organic solvent, a lithium salt, and the additive.

11. A battery pack, comprising the secondary battery according to claim 1.

12. An electronic device, comprising the secondary battery according to claim 1.

13. An electric vehicle, comprising the secondary battery according to claim 1.

14. An energy storage device, comprising the secondary battery according to claim 1.
